(19) United States
(12) Patent Application Publication
(10) Pub. No.: US 2003/0096621 A1
(43) Pub. Date: May 22, 2003

(54) Method and apparatus for identifying a group of users of a wireless service

(76) Inventors: Rittwik Jana, Pinebrook, NJ (US); Theodore Johnson, New York, NY (US); Shanmugavelayutham Muthukrishnan, Washington, DC (US); Frederick Kenneth Schmidt JR., Califon, NJ (US)

Correspondence Address: Samuel H. Dworetsky, AT&T CORP., P.O. Box 4110, Middletown, NJ, 07748-4110, US

(21) Appl. No.: 09/992,804

(22) Filed: Nov. 19, 2001

(51) Int. Cl. H04Q 7/20

(52) U.S. Cl. 455/456; 455/414; 455/445

(57) ABSTRACT

A method and system are provided to extract information based on activities of a plurality of mobile users, which involve tracking movement of a plurality of mobile users across one or more wireless networks; identifying a group of mobile users engaged in one or more common location-based activities from the plurality of mobile users based on the tracked movement; and determining one or more group properties associated with the group of mobile users. The method and system may further involve deriving a group condition based on the one or more determined group properties, and providing customized services to at least one mobile user of the group based on the derived group condition.

### BACKGROUND OF THE INVENTION

1. Technical Field

The present invention is generally related to a method and apparatus for grouping wireless users and, more particularly, for deriving useful information and/or customizing services based on the activities of a group of wireless users.

2. Art Background

As wireless technology advances, mobile devices are becoming more and more affordable and at the same time providing greater functionality. People are increasingly dependent on the use of mobile devices in their daily lives. The wireless medium presents another area of untapped potential to gather useful information and to provide services to mobile users.

### SUMMARY

In one embodiment, a method and system are provided to extract information based on activities of a plurality of mobile users, which involve tracking movement of a plurality of mobile users across one or more wireless networks; identifying a group of mobile users engaged in one or more common location-based activities from the plurality of mobile users based on the tracked movement; and determining one or more group properties associated with the group of mobile users. The method and system may further involve deriving a group condition based on the one or more determined group properties, and providing customized services to at least one mobile user of the group, or a person or entity outside the group, based on the derived group condition.

The location-based activity may include, for example, traveling in a geographic region, attending a meeting, attending a conference, attending a wedding or attending a sporting event.

In a further embodiment, the method and system may further involve identifying a second group of mobile users having a potential interest in obtaining the group condition or group property and providing the group property or condition to the one or more mobile users of the second group.

In another aspect, the method and system may involve dynamically updating group information corresponding to the mobile users of the group. The updating may include modifying the group information to reflect one of an addition of a new mobile user to the group, or a deletion of a mobile user from the group, and/or modifying the group information to reflect such new activity information of mobile users of the group.

In another embodiment, a method and system are provided to extract information based on activities of a plurality of mobile users, which involve tracking a plurality of mobile users across one or more wireless networks; identifying a group of mobile users sharing one or more common traits from the plurality of mobile users; and providing customized services to at least one mobile user of the group, or a person or entity outside the group. For example, the movement of the mobile users may be tracked and a group of mobile users engaged in one or more common location-based activities may be identified.

In yet another embodiment, a method and system are provided to extract information based on activities of a plurality of mobile users, which involve tracking a plurality of mobile users across one or more wireless networks; identifying a group of mobile users sharing one or more common traits from the plurality of mobile users; and determining one of a number of possible group conditions or properties of the identified group of mobile users.

Other and further embodiments will become apparent during the course of the following description and by reference to the attached drawings.

### BRIEF DESCRIPTION OF THE DRAWINGS

FIG. 1A illustrates an overall view of a network environment including wireless devices in accordance with one advantageous embodiment;

FIG. 1B illustrates an overall view of a network environment including wireless devices in accordance with another advantageous embodiment;

FIG. 2 illustrates a block diagram of exemplary components of a mobile device of FIGS. 1A and 1B;

FIG. 3 illustrates a block diagram of exemplary components of a host server of FIGS. 1A, 1B and 2;

FIGS. 4A and 4B illustrate a graphical representation of a grouping and update of the group of mobile devices/users from a plurality of mobile devices/users;

FIG. 5A illustrates an exemplary movement tracking database;

FIG. 5B illustrates an exemplary location-based activity database;

FIG. 5C illustrates an exemplary group database;

FIG. 6 illustrates an exemplary process by which movement information of mobile devices/users are tracked, stored and/or updated;

FIG. 7 illustrates an exemplary process by which group information of mobile devices/users are updated;

FIG. 8 illustrates an exemplary process by which mobile devices/users are added to a group;

FIG. 9 illustrates an exemplary process involving the tracking and classification of mobile devices/users into group(s); and

FIG. 10 illustrates an exemplary process by which services may be provided to mobile users.

### DETAILED DESCRIPTION OF THE PREFERRED EMBODIMENTS

A method and system are provided to track a plurality of wireless or mobile users (hereinafter “mobile users”) and to identify one or more groups of mobile users from the plurality of mobile users sharing one or more common or similar traits or characteristics, such as a group of mobile users being engaged in one or more common or similar activities. Once a group is identified, it is possible to derive useful information based on the activities of the grouped mobile users or personal characteristics or information of the users of the group. Such useful information may, for example, include a group condition or group property. This information may thereafter be provided to interested parties or utilized to provide services to various parties including the mobile users.

An “activity” generally refers to actions or on-goings of a mobile user. Examples of activities may include location-based activities, such as attending a particular meeting, riding a particular train or bus, or riding in a motor vehicle (e.g., car, truck, etc.) traveling on a particular highway. Other examples of activities may involve usage or operation of a mobile device, such as call usage, Internet browsing, electronic transactions, application usage (e.g., games, programs, etc.) and so forth.

A “group property” generally refers to a trait or characteristic or profile of a group of users. Examples of a group property may include movement characteristics of the group such as a group speed or velocity, group traffic pattern, call usage pattern, browsing pattern, group age range (e.g., 18 to 25 years old), etc. or an activity which is engaged in by all or a significant portion of the users in a group such as engaging in trading of financial instruments.

A “group condition” generally refers to a condition, such as an environmental condition, affecting the group or derivable based on the activities of the users in the group. Examples of a group condition may include a level of traffic congestion (e.g., traffic jam or congestion), traffic patterns, changes in traffic patterns, popularity of a service among a user population and so forth.

In other aspects, group identification and classification may also be employed to facilitate customization of services to one or more or all mobile users of the group. Services may be predefined according to the shared activity or trait; or services may be personalized according to the activities or personal characteristics or personal information of the mobile users of the group or according to a group property or condition. A few examples of possible services may include, for example, the following:

(1) Information services can be offered to mobile users in-transit to alert them of current or upcoming travel-related problems (e.g., traffic jam, severe weather condition, estimated time to destination, average speed of traffic ahead, etc.) based on their current mode of transit (e.g., road being driven, train being ridden, etc.);

(2) Services can be provided to government or commercial entities that are dependent on road and highway information;

(3) Services can be provided in the form of real-time alerts or long-term and wide-scale aggregated information;

(4) Services can be provided to a group attending a convention or special event. Such services can be developed by third parties without any knowledge of the users' individual addresses, phone numbers, etc., since the service provider would have all of that information on its database.

To facilitate group classification, a data feed containing updates of mobile user information (such as location information or other mobile user information) may be collected into a database. The data feed can be obtained from a variety of sources, e.g., through network elements or through explicit communication with the mobile device of a mobile user. For example, information about the location of a mobile user can be obtained through sources such as periodic cell phone registrations with mobile switching centers, updates from mobile GPS units, and so on. The database may be centralized or distributed, may be a general-purpose user location database, may be specialized to a particular task, or may be federated from a number of special purpose databases.

A variety of mobile user information can be collected in the database, including calling and browsing patterns of a mobile user, a vector of recent location updates (and the timestamps of these updates) of a mobile user, profile information about a mobile user (including preferred travel routes), and so on. Based on this information, mobile users can be dynamically categorized into groups that share similar properties or traits and services can be customized for such mobile users.

As one illustrative example, the method and system discussed herein may be applied to detect environmental conditions, such as traffic jams or congestion, by tracking movement or location of a plurality of mobile users. For example, cell towers generally tend to be located near highways. When a mobile user's device communicates with a cell tower that services a particular road (e.g. Route 24) the user may be identified and classified as part of a group of similar mobile users who are engaged in a common location-based activity, e.g., traveling on Route 24.

The identification or classification of the mobile user in the group may involve iterative or multiple operations of tracking and analyses of user activities to verify that the user is engaged in a particular location-based activity. For example, the mobile user may simply be in a service area of the cell tower (next to Route 24), and not be traveling on Route 24. In this situation, if the mobile user passes through a succession of consecutive cell towers each of which is associated with Route 24, it can be deduced that the user is either traveling on Route 24, or on a local road which roughly parallels Route 24 (such as Route 124). To determine whether mobile users are traveling on Route 24 or a local parallel road, a comparison can be made based on the speed of the mobile users. Mobile users traveling at faster speeds or in a particular speed range can be grouped as users traveling on Route 24 and those users traveling at slower speeds or in a lower speed range can be grouped as users traveling on the local road.

Once a group of mobile users traveling on Route 24 have been identified, their activities may be further analyzed to determine the traffic conditions on the road. For instance, a change of the group speed to a significantly lower speed or the group speed being significantly lower than the allowable speed limit may be an indicator of a traffic jam or congestion. This information can be provided to an interested party, such as a traffic reporting service or to mobile users in the group or other mobile users nearing the traffic jam or congestion. To address mobile users' privacy concerns, the tracked mobile users can be anonymized, with only the aggregate information about a group being distributed.

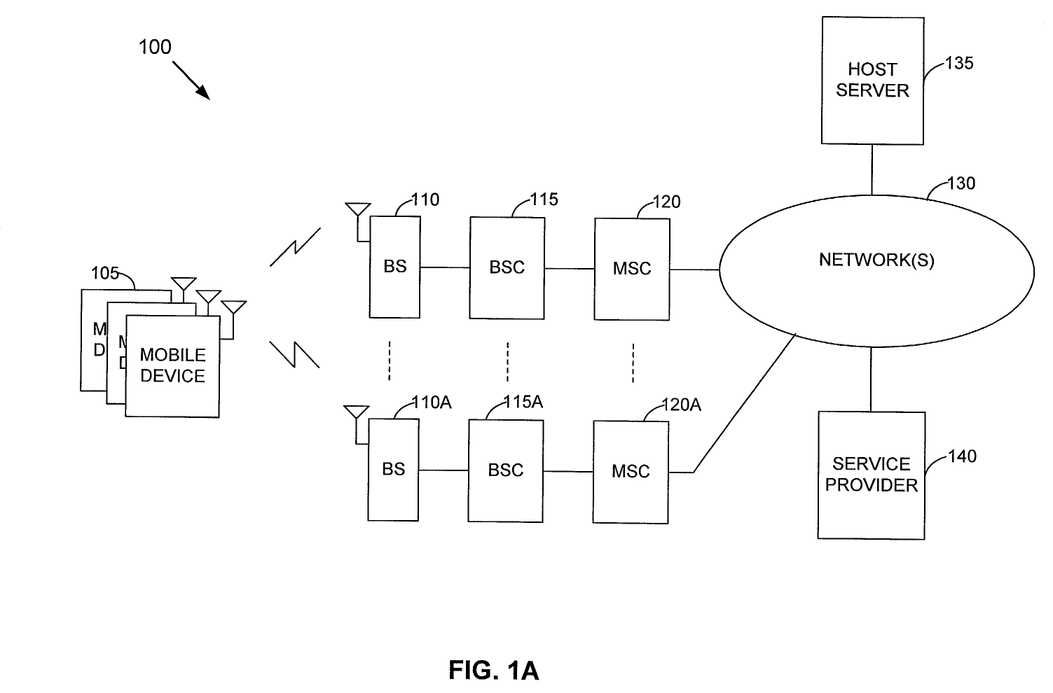

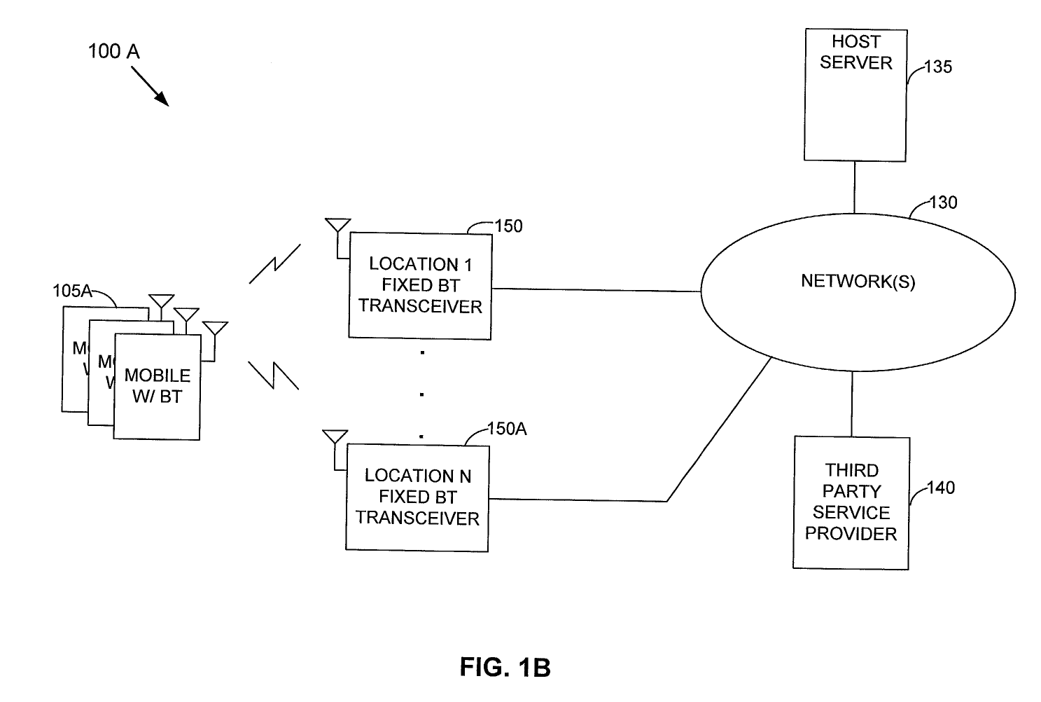

Turning to a more detailed description, the various embodiments will be discussed generally in regard to location-based activities although other types of activities or traits may be utilized as factors in grouping mobile users. FIG. 1A illustrates one example of an overall view of a network environment 100 including a plurality of mobile users in accordance with one advantageous embodiment. Network environment 100 includes one or more mobile devices 105 configured to conduct wireless communications across a plurality of base stations 110 . . . 110A, base station controllers 115 . . . 115A and mobile switching centers 120 . . . 120A connected to a host server 135 and a service provider 140 across network(s) 130. Network(s) 130 may include public switch telephone network (PSTN), local area network (LAN), wide area network (WAN) and/or other line-based or wireless-based networks to facilitate communications between the different networked devices or components.

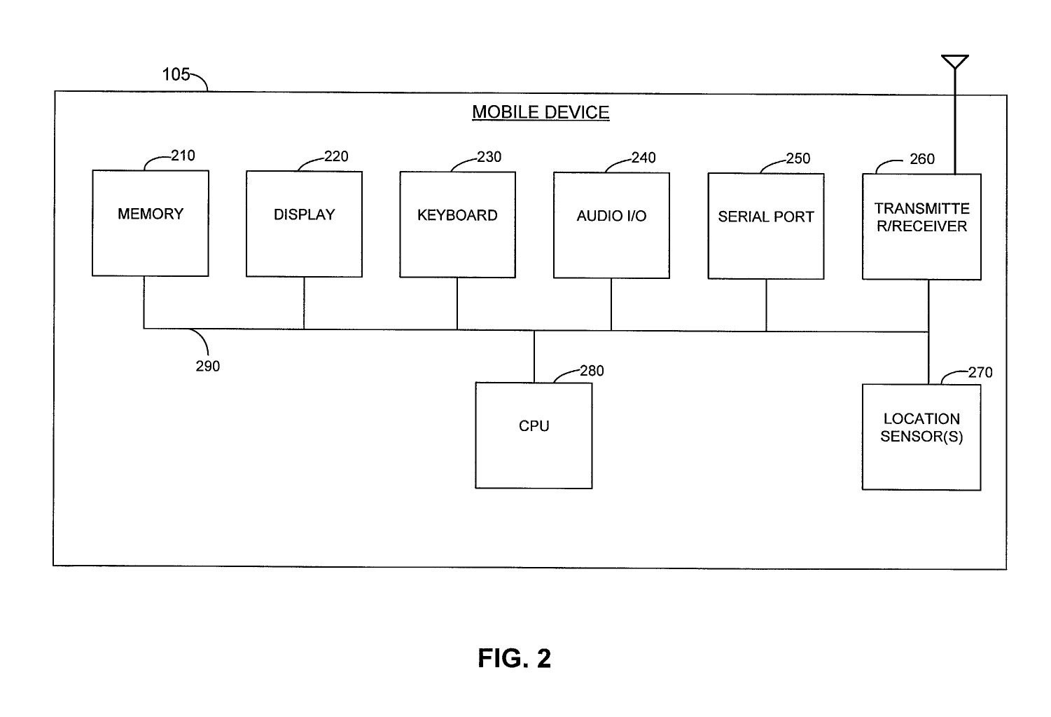

Mobile device 105 may take the form of a processor-controlled wireless communications device, such as a cellular phone or the like, personal digital assistant (PDA), pager, or any device capable of conducting wireless voice and/or data communications including communications via the Internet through a browser. Mobile device 105 may be a portable device operated by a user or a fixed device in a moving vehicle (e.g., car, train, etc.) or other desired location. Exemplary components and functionality of mobile device 105 are discussed further below with reference to FIG. 2. The terms “mobile device” and “mobile user” are utilized interchangeably herein.

Host server 135 may take the form of a server including conventional server components and functionality. Host server 135 may be operated by a trusted third party, a wireless communications service provider and so forth.

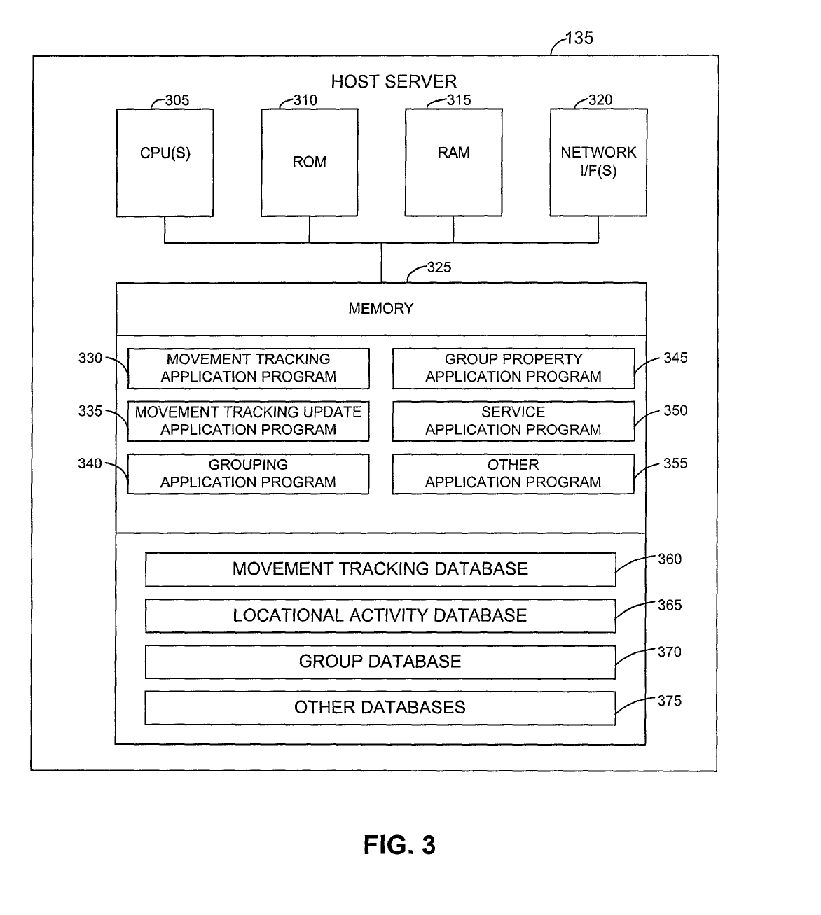

In various embodiments, host server 135 is configured to track and update information on a plurality of mobile users, to identify a group of mobile users from the plurality of mobile users sharing a common or similar trait(s), such as being engaged in a common or similar activity, to derive a group property or trait of the group of mobile users, to determine a group condition (e.g., environmental condition) associated with the group and/or to provide customized services to one or more or all members of the group. Exemplary components and functionality of host server 135 are discussed further below with reference to FIG. 3.

The various services may include traffic information services such as warnings, alternate routings, locale announcements, stock and other news, etc.; electronic shopping services; entertainment services such as music streamed to a mobile or fixed device based on Time of Day (TOD) and/or group and/or location settings, video streamed based on group training, multi-user gaming, road information or previews of coming attractions; and/or other types of personalized or customized services.

Service provider 140 may be a party operating one or more servers or computerized systems to provide a variety of electronic-based services, such as those discussed above with respect to host server 135. Service provider 140 may be a consulting agency, traffic agency, electronic retailer, information provider and/or communications provider. The one or more servers or computerized systems may include conventional computer components, such as one or more processors, network interfaces, and memory, to facilitate provision of services to their customers.

In various embodiments, service provider 140 may be configured to receive group-related information from host server 135, directly or indirectly, to determine a group condition or environmental condition associated with the group and/or to provide customized services to one or more or all members of the group. Service provider 140 may include similar components and functionality as that of host server 135 (which are discussed generally above and further below with reference to FIG. 3).

Base stations 110, 110A, base station controllers 115, 115A and mobile switching centers 120, 120A provide a fixed supporting network to enable wireless communications of voice and data. The general components and operations of these components are generally well known and will not be described in further detail. However, a general discussion of mobile location is discussed immediately below to provide general background in regard to one approach of tracking movement or temporal activities of mobile device.

For example, when an incoming call is received for a mobile device, the call is routed to the cell where the mobile device is located so that the call can be connected. One way of locating the mobile device would be to transmit a calling message (page) for the mobile device on every cell site in the network. Alternatively, the cellular network is split up into a number of location areas, each with its own area identity number. This number is then transmitted regularly from all base stations in the area as part of the system's control information. A mobile device, when not engaged in a call, will lock on to the control channel of the nearest base station and, as it moves about the network, will from time to time select a new base station to lock on to. The mobile device checks the area identity number transmitted by the base station; and when it detects a change, indicating that the mobile device has moved to a new location area, it will automatically inform the network of its new location by means of a signaling interchange with the base station. In this way, the network can keep a record (registration) of the current location area of each mobile and therefore be able to communicate with the mobile device within that area.

Accordingly, in regard to one embodiment, the movement of a mobile device may be tracked through the registration processes discussed above. A time stamp may be associated with each registration to identify a time at which registration occurred.

Alternatively, the mobile device may include a location sensor for determining its current position and forwarding such location information and an associated time stamp to the host server. For example, the mobile device may include a cell-triangulation sensor for triangulating the location of the device based on the area identity transmission or the like of base stations (e.g., based on at least three of the strongest base station signals), GPS system or other types of sensors or combination of sensors to identify a location of the device.

FIG. 1B illustrates an overall view of a network environment 100A including wireless devices in accordance with another advantageous embodiment. Network environment 100A includes one or more Bluetooth-enabled mobile devices 105A configured to conduct wireless communications across a plurality of fixed position Bluetooth-enabled transceivers 150 . . . 150A connected to a host server 135 and a service provider 140 across network(s) 130. Mobile device 105A and transceivers 150, 150A conduct wireless communications through use of the Bluetooth™ standard (“Bluetooth” is a trademark owned by Telefonaktielbolaget L M Ericsson, Sweden.). Network(s) 130 may include public switch telephone networks (PSTN), local area networks (LAN), wide area networks (WAN) and/or other line-based or wireless-based networks to facilitate communications between the different networked devices or components.

The Bluetooth standard is a short-range wireless communication industry specification that allows portable, personal devices to interact with each other and other stationary devices. The Bluetooth standard uses the spread spectrum radio frequency and provides omnidirectional multiple connections without requiring communicating devices to be in line of sight. The maximum range is 10 meters, but it can be extended to 100 meters by increasing the power. When one Bluetooth device comes within range of another, they automatically exchange address and capability details. They can then establish a 1-megabit/second link with security and error correction. The device's radio operates on the globally available, unlicensed 2.45 GHz radio band, and supports data speeds of up to 721 Kbps. Each device has a unique 48-bit address similar to that provided in the IEEE 802 standard. Connections can be point-to-point or multipoint. Bluetooth devices are protected from radio interference by changing their frequencies randomly up to a maximum of 1600 times per second, using a frequency hopping protocol. They also use three different but complimentary error correction schemes. Built-in encryption and verification are provided. Bluetooth devices provide a universal bridge to existing data networks, a peripheral interface, and a mechanism to form small private ad hoc groupings of connected devices away from fixed network infrastructures. Bluetooth radio modules avoid interference from other signals by hopping to a new frequency after transmitting or receiving a packet. The Bluetooth specification is a de facto standard containing the information required to ensure that diverse devices supporting the Bluetooth wireless technology can communicate with each other worldwide.

While FIGS. 1A and 1B illustrates two different examples of a wireless environment or network, other wireless environments may also be employed by mobile devices 105, 105A to conduct voice and data communications, including Internet communications. For example, mobile devices 105, 105A may communicate across a public or private wireless LAN implementing the IEEE 802.11 standard (“Wi-Fi” standard), e.g., at an airport, hotel and so forth. As one illustrative example, host server 135 can be configured to identify mobile users from the same company on the wireless LAN at a locality (e.g., airport) and customize a service profile to emulate their office environment, allowing them to interact on the wireless LAN as if they were inside their Office firewall. Information or data to customize the service profile may be obtained from the mobile user, from the company's LAN or predefined and maintained by host server 135. For example, this information or data may include the general office computer settings of the company (e.g., operating system, application programs, etc.) as well as the personal setting of the company employees.

FIG. 2 illustrates a block diagram of exemplary components of mobile devices 105, 105A (hereinafter referred as “mobile device 105”) of FIGS. 1A and 1B. Mobile device 105 may include a memory 210, display 220, keyboard 230, audio input/output (I/O) 240, serial port 250, transmitter/receiver 260, location sensor(s) 270 and a central processing unit (CPU) 280. These components interact with one another across a bus or connector 290. Mobile device 105 may take the form of a cellular device, Personal Digital Assistant (PDA), pager, portable computer, or any device able to conduct wireless communications.

In various embodiments, mobile device 105 may provide movement information, such as location or position, either passively or actively to a party such as host server 135. Passive provision of movement information may involve registration of the mobile device with the mobile network, such as with cellular units, or a service discovery/negotiation operation involving a fixed position Bluetooth transceiver with a Bluetooth-enabled mobile device. Such information may thereafter be time-stamped and forwarded to host server 135 to perform the various processes discussed herein.

Active provision of information may entail mobile device 105 determining movement characteristics—for example, through use of location sensors—and providing such information to a party such as host server 135 to perform the various processes discussed herein. Such sensors may include GPS, cellular position triangulation sensor and/or other sensors to sense movement characteristics of the mobile device or to sense environmental characteristics to enable determination of movement characteristics.

Additionally, mobile device 105 may store locally, such as in memory 210, personal information or data of the mobile user and/or the device. For example, such personal information or data of the mobile user may include the user's personal assets such as the user's profile, usage patterns, mobile device settings, preferences, etc. Personal information or data of the mobile device may include device identifiers, and application programs as well as other information defining the various functions and features of the mobile device. This information or data may be provided to host server 135 to facilitate group identification, property or condition determination, and service customization, as discussed herein.

FIG. 3 illustrates a block diagram of exemplary components of host server 135 of FIGS. 1A, 1B and 2. Host server 135 may include CPU(s) 305, ROM 310, RAM 315, network interface(s) (I/Fs) 320 and memory 325.

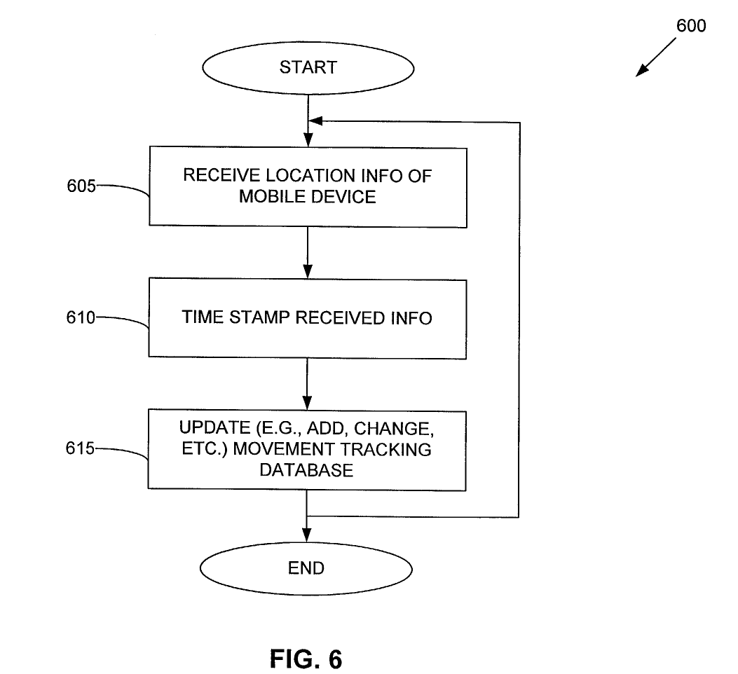

As shown, memory 325 may store a variety of data and application programs or code to implement the various processes discussed herein as well as to perform general server system operations or functions (e.g., operating system, drivers, etc.). For example, memory 325 may store application programs, including movement tracking application program 330, movement tracking update application program 335, grouping application program 340, group property application program 345, service application program 350 as well as other application programs 355. The various processes implemented through such application programs are discussed in further detail below with reference to FIGS. 6 through 10.

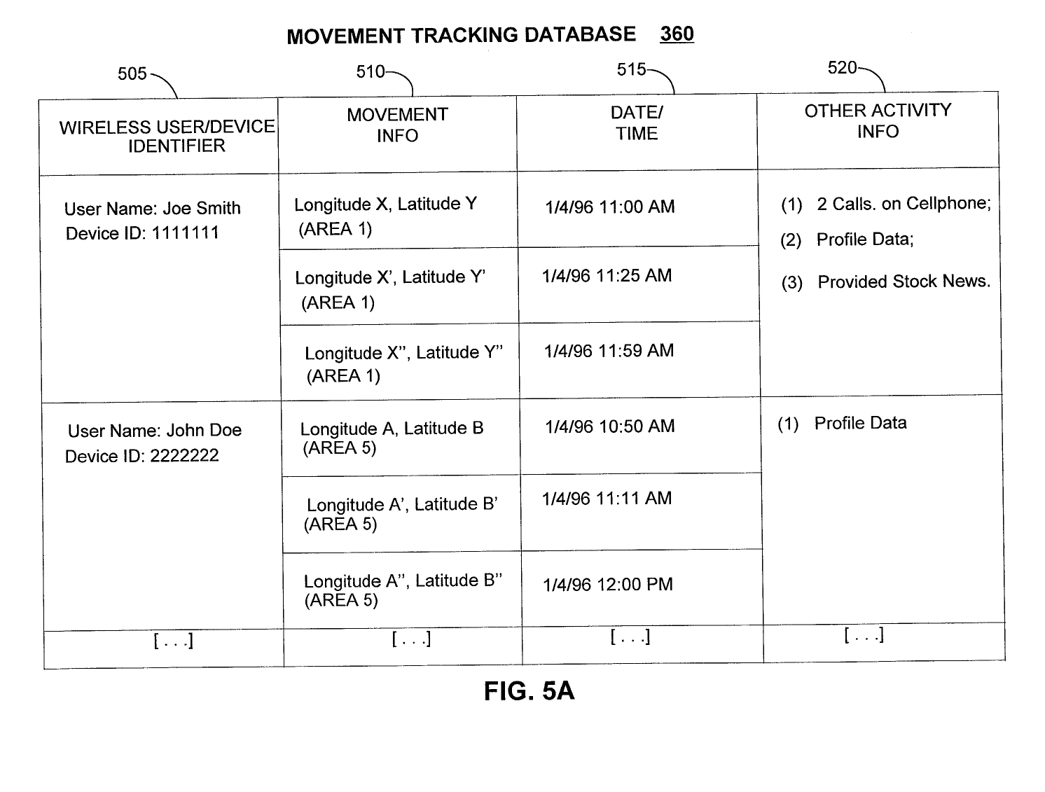

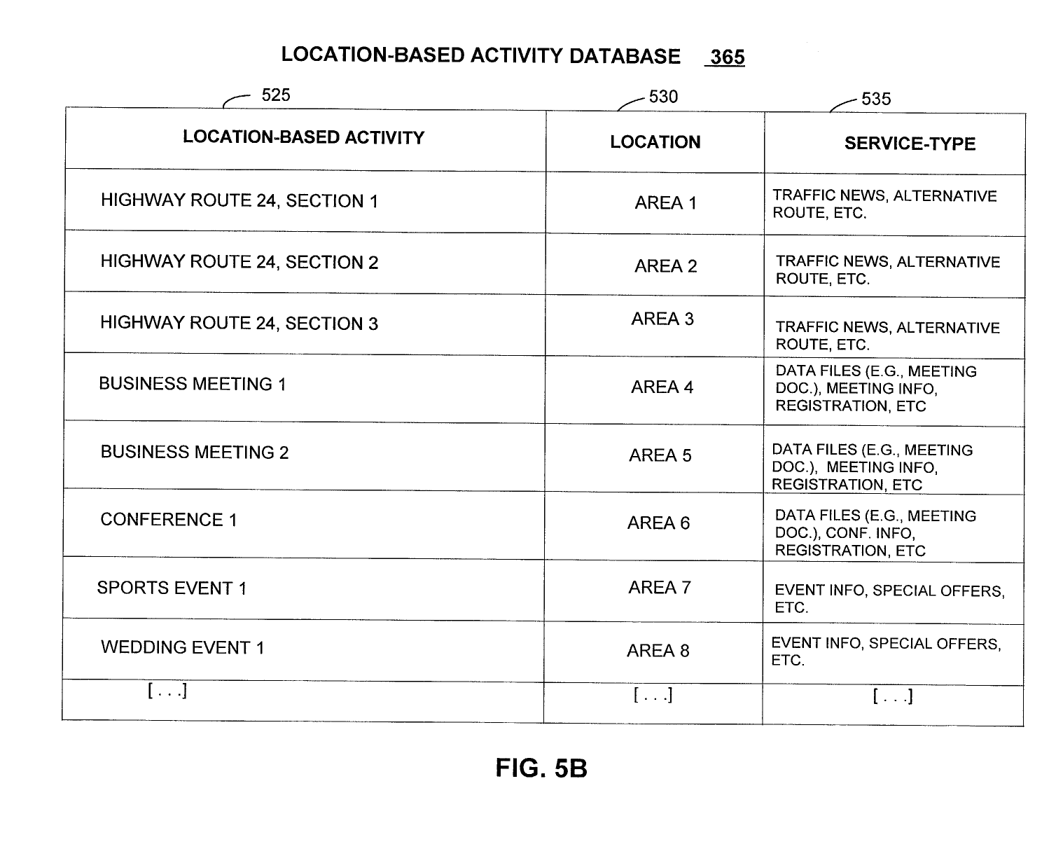

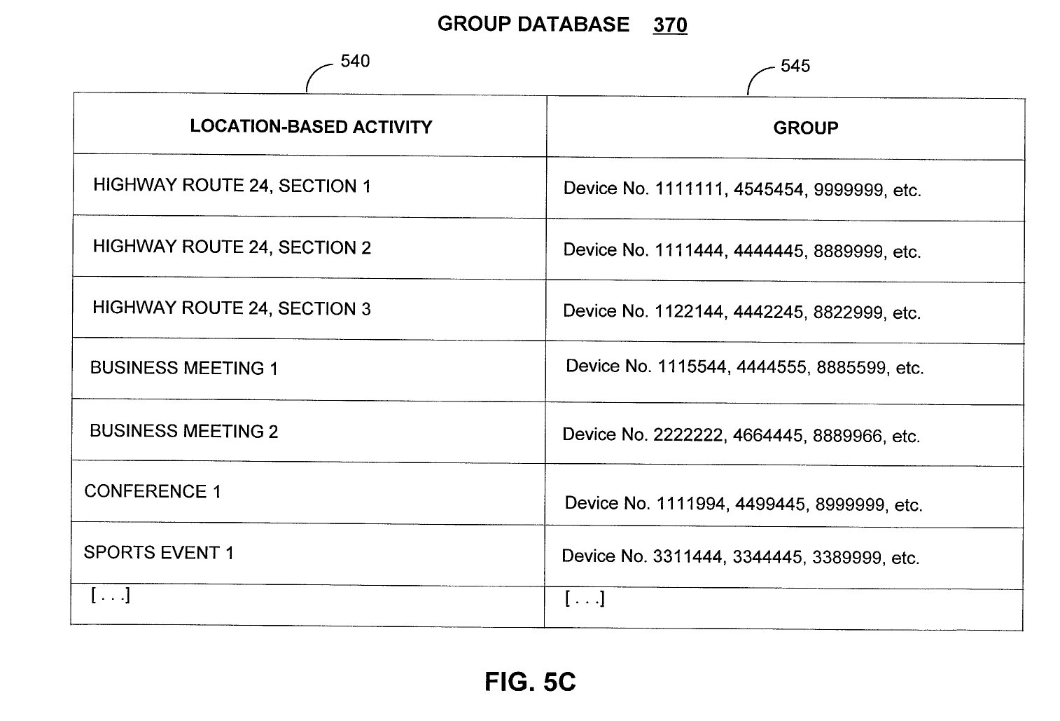

Memory 325 may also maintain databases, such as movement tracking database 360, location activity database 365, group database 370 as well as other databases 375. Examples of such databases are discussed in further detail below with reference to FIGS. 5A through 5C.

While the various information and data are shown in one example as being maintained in memory 325, such information and data may be stored at different remote locations, as desired, that are accessible to host server 135. The database may also be federated from a number of special purpose databases.

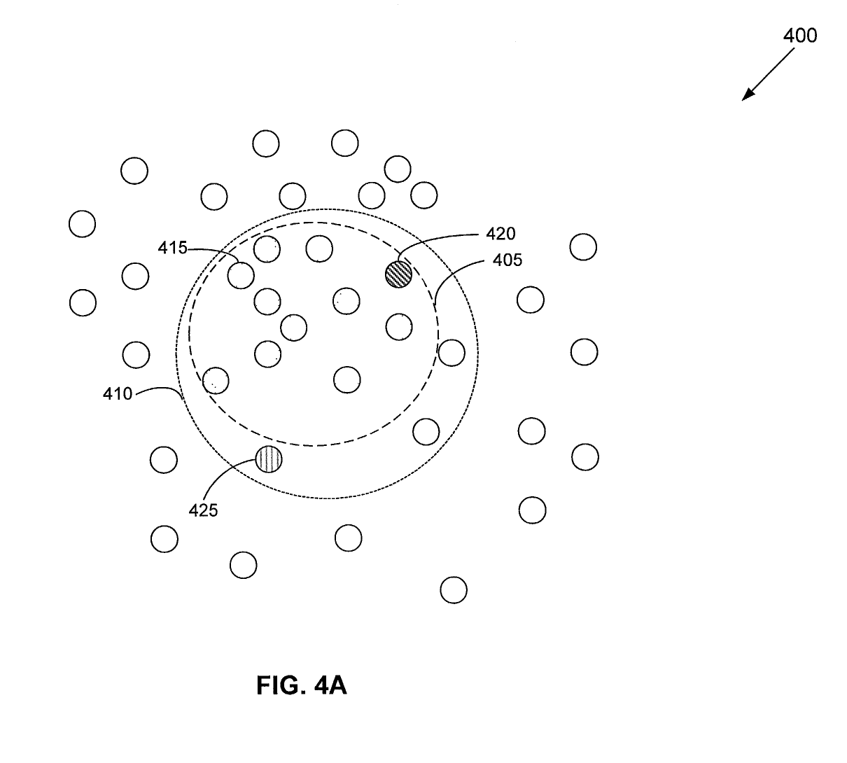

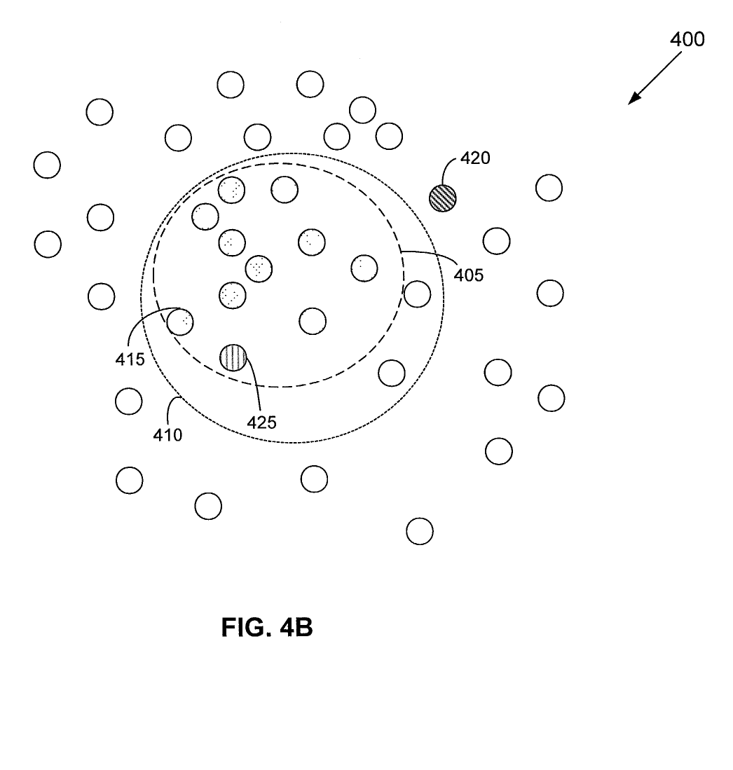

FIGS. 4A and 4B illustrate a graphical representation of a grouping and update of information of a group of mobile devices/users from a plurality of mobile devices/users 400. As shown in FIG. 4A, a group of mobile devices may be identified from a plurality of mobile devices based on common or similar activities, such as location-based activities based on tracking information. For example, the identified group is denoted by the dotted circle 405 with a member of the group identified by reference numeral 415.

As shown by reference to FIG. 4B, information on the members of the group may be modified dynamically or at desired times (e.g., periodically, at predefined times, upon a triggering event, manual command, etc.) due to changes in circumstances. These modifications may involve removing mobile device(s) from the group such as shown by mobile device 420, or adding mobile device(s) from the group such as shown by mobile device 425. To minimize the searchable range employed in modification of a group, it is also possible to define an outer search range or boundary denoted generally by the dotted circle 410. This provides a filter to reduce the amount of data processing without affecting or substantially affecting the accuracy of the group information.

FIG. 5A illustrates an exemplary movement tracking database 360 for maintaining movement information on a plurality of mobile devices/users. Database 360 may include a wireless user/device identifier field 505, movement info field 510, date/time field 515 and other activity info field 520.

Wireless user/device identifier field 505 maintains identification information on tracked mobile devices and/or users, and may also include contact information (e.g., IP address, email, phone number, etc.) to enable communication with the mobile device/user. Such identification information may include the name of the user (e.g., Joe Smith) and/or his/her device identifier (e.g., 1111111). Identification information may take any form suitable to enable identification of a mobile user or the mobile device.

Movement info field 510 maintains movement information for each mobile device/user, and corresponding date/time field 515 identifies the time at which the information was determined or received. Movement information may include a position or location of the mobile device. The position or location may take the form of a specific geographic area (e.g., area 1, area 5, etc.), longitude/latitude, street address, or any form in which a location or vicinity of the device may be determined. Movement information may take other forms including movement characteristics, such as a route, velocity, acceleration, etc.

By tracking the position and time, it is possible to determine the speed or velocity at which a mobile device/user is traveling as well as the route. Such information may be employed to determine a traffic condition or other group properties.

Other activity info field 520 maintains other personal information or data of the mobile device/user. Such information may include a number of calls on a mobile device such as a cellular phone, private user data or personal assets (e.g., profile data), services employed by the user (e.g., stock news), web sites or pages accessed by the user, and so forth. This information or data may be employed to group mobile users, to determine condition or property, and/or to provide personalized/customized services.

FIG. 5B illustrates an exemplary location-based activity database 365 for maintaining information on various location-based activities and data associated therewith. Database 365 may include a location-based activity field 525, a location field 530 and a service-type field 535.

Location-based activity field 525 identifies various location-based activities, such as a particular highway or road, business meeting, conference, sports event, wedding and so forth.

Location field 530 identifies a location or vicinity of a location-based activity. Such information may be expressed as a geographic area (e.g., area 1, area 2, etc.) as shown in FIG. 5B or any other form identifying a location or geographic position such as longitude/latitude boundaries, an address (e.g., 1 John Doe Avenue), and so forth.

Service-type field 535 identifies the various types of services to be offered to a mobile user depending on the location-based activity. For example, a mobile user on highway Route 24, section 1 may be provided with traffic news, alternative routes, etc. A mobile user attending business meeting 1 may be offered data files (e.g., meeting documentation), meeting information (e.g., name of the speakers, attendees, general meeting information or summaries, etc.), an opportunity to register, and so forth. The types of services may be predetermined for each location-based activity and/or the service offering may be dynamically determined based upon information derived or obtained from the group of mobile users engaged in the particular location-based activity.

For example, the activities of a group of mobile users may be analyzed to determine an activity engaged in by one or more mobile users in the group. The activity may involve electronic trading of stocks, bonds or other financial instruments. One or more services, such as financial news, may then be provided to those engaged in the activity or the entire group.

In another example, the activities of a group of mobile users may be analyzed to determine service activities engaged in by one or more mobile users in the group. The service activity may involve accessing a particular financial web site. Such service activities may be offered to the other mobile users in the group.

FIG. 5C illustrates an exemplary group database 370 for categorizing or classifying mobile devices/users into one or more groups. Database 370 includes a location-based activity field 540 for identifying a particular location-based activity and a group field 545 for identifying mobile devices/users engaged in a particular location-based activity. For example, the group of mobile users traveling on highway Route 24, section 1 include mobile device nos. 1111111, 4545454 and 9999999.

Various examples of the processes performed by host server 135 are discussed below with reference to FIGS. 6 through 10. Although the examples are discussed with reference to host server 135, the processes may be performed by or in combination with other networked systems, such as at BSC, MSC, fixed position Bluetooth-enabled transceiver, and so forth. For example, to increase security over personal information of the mobile users, the various processes discussed herein may be implemented by a wireless service provider or some trusted party.

FIG. 6 illustrates an exemplary process 600 by which movement information of mobile devices are tracked, stored and/or updated. The process commences at step 605 in which host server 135 receives movement information, such as location information, of a mobile device. At step 610, host server 135 time stamps the received movement information or, alternatively, receives the time information at which the movement information was received or identified by another device. At step 615, host server 135 updates movement tracking database 360 with the movement information of the mobile device as well as the time stamp.

The process 600 may be continuously implemented to track and update the movement of a plurality of mobile devices as well as to track other activities or to obtain personal information of such devices or their users. For example, host server 135 may request information, such as personal assets (e.g., profile data, etc.), from the mobile users/devices or may be provided such information automatically by the mobile users/devices.

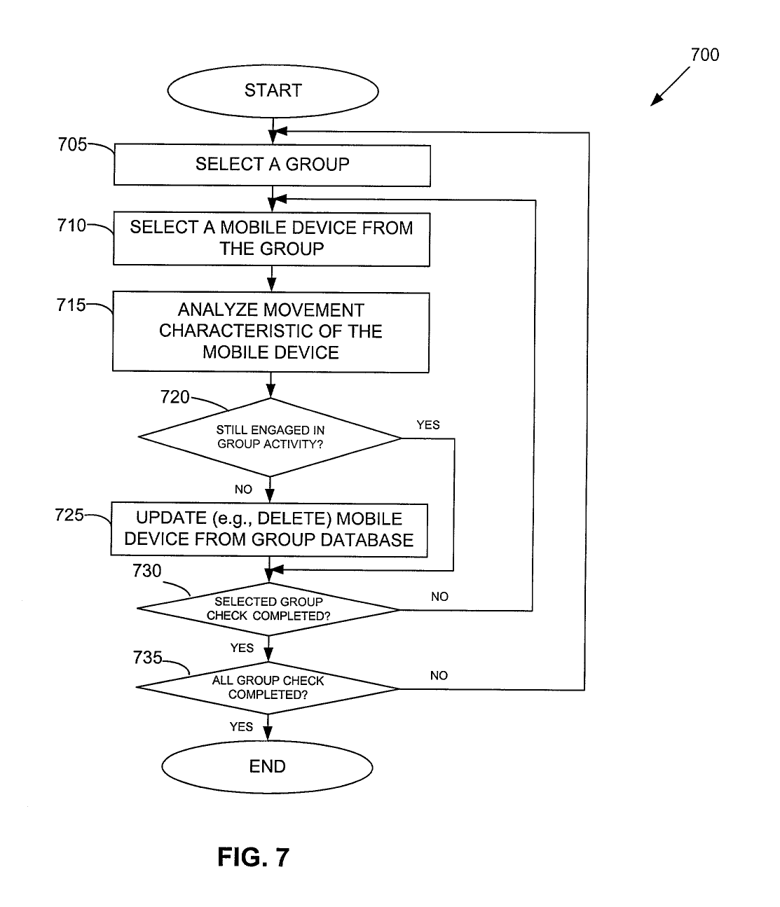

FIG. 7 illustrates an exemplary process 700 by which group information of mobile devices and their users are updated. The process commences at step 705 in which host server 135 selects a group from a plurality of groups of mobile devices. At steps 710 and 715, host server 135 selects a mobile device from the selected group and analyzes movement characteristics of the mobile device. At step 720, host server 135 determines whether the mobile device is still engaged in the group activity, e.g., the activity or activities defining a member of the group. If the selected mobile device is no longer engaged in the group activity, then host server 135 updates group database 370 by deleting or removing the mobile device from the group or by noting that the mobile device is no longer engaged in the group activity while continuing to track the movement characteristics of the mobile device.

By tracking an ex-member of the group, additional useful information may be obtained that may be relevant to the particular group. For example, in a traffic scenario, tracking ex-members of a group traveling on Route 24, section one may provide additional information, such as an alternative route(s) in the event of traffic congestion on Route 24, section one or generally traffic congestion downstream on Route 24.

Turning back to step 720, in cases whether the selected mobile device is still engaged in the group activity, the process proceeds to step 730 in which host server 135 determines whether all mobile devices in the selected group have been checked. If not, another mobile device is selected at step 710 and the steps 715 through 730 are repeated from that mobile device. Otherwise, at step 735, host server 135 determines whether all groups have been checked. If not, another group is selected at step 705 and the steps 710 through 730 are repeated for that group. Otherwise, the process 700 terminates.

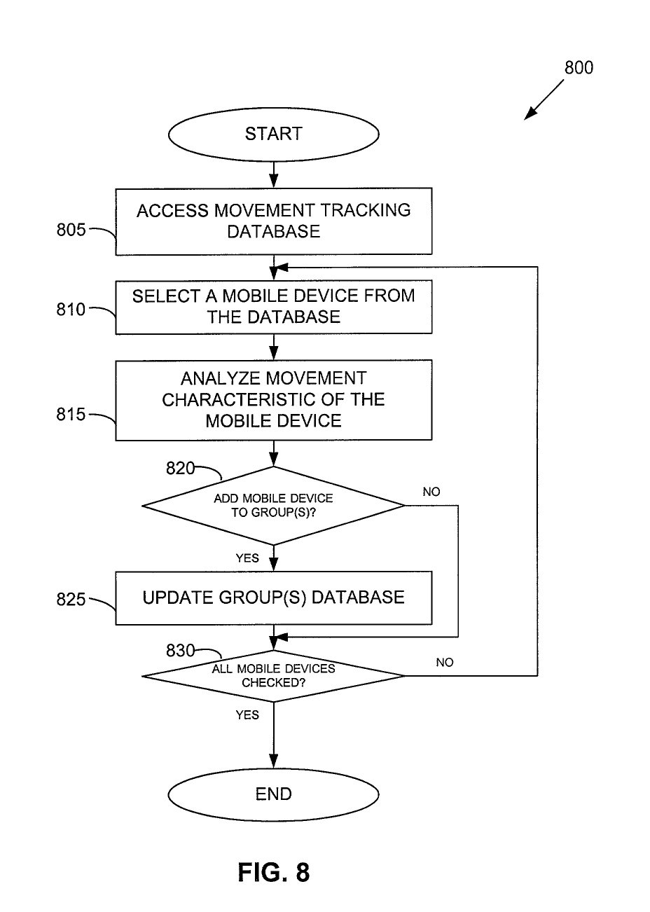

FIG. 8 illustrates an exemplary process 800 by which mobile devices and their users are added to a group. The process commences at step 805 in which host server 135 accesses movement tracking database 360. At steps 810 and 815, host server 135 selects a mobile device and analyzes movement characteristics of the mobile device, respectively. At step 820, host server 135 determines whether to add the mobile device to one or more groups. For example, a mobile device/user is added to a group if the mobile device/user shares one or more similar or common traits, such as being engaged in one or more common or similar activities with the group members (e.g., location-based activity or other activity).

If the mobile device is to be added, host server 135 updates group database 370 by adding the mobile device to one or more appropriate groups at step 825.

In either case, at step 830, host server 135 checks whether all mobile devices have been checked. If not, the process 800 proceeds back to step 810 to select another mobile device which has not been selected and accordingly implements steps 815-830 for the newly selected device. Otherwise, the process 800 terminates.

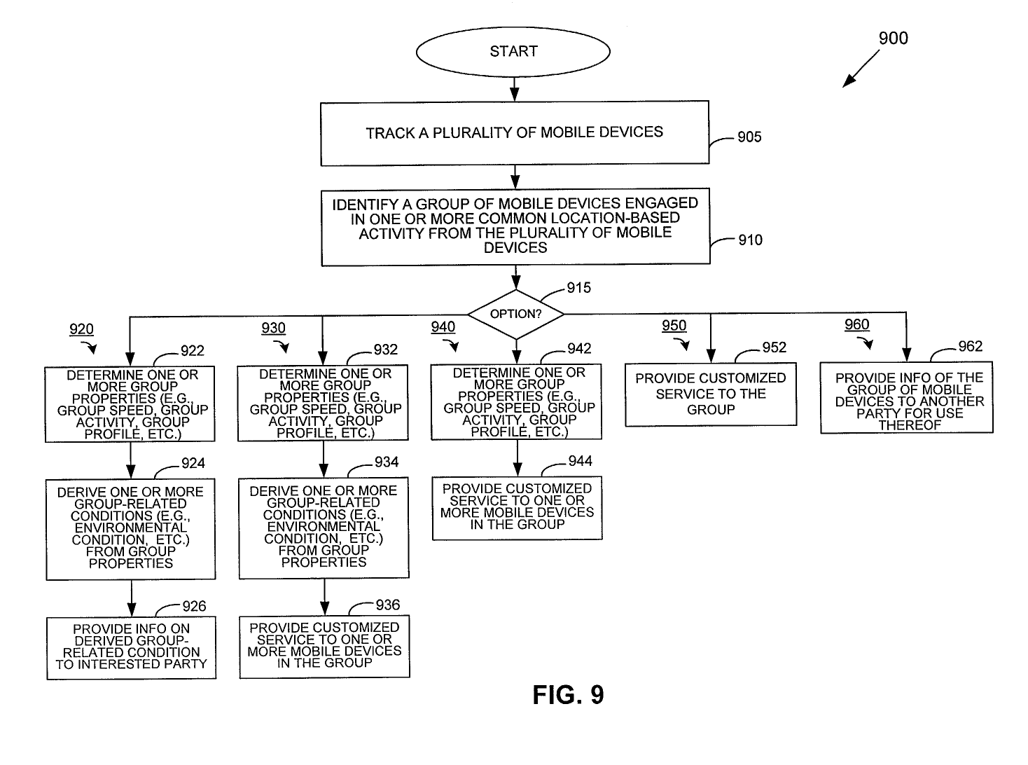

FIG. 9 illustrates an exemplary process 900 involving the tracking and classification of mobile devices/users into group(s), determination of group properties and group conditions, and provision of customized services.

The process 900 commences at step 905 in which host server 135 tracks a plurality of mobile devices. Such tracking may involve tracking the movement and/or other activities of the mobile devices with tracking information being maintained and updated at a storage facility. Tracking information may, for example, be maintained in movement tracking database 360. At step 910, host server 135 identifies a group of mobile devices sharing one or more common or similar traits. Such traits may include being engaged in a common or similar activity, such as in this case a location-based activity which can be determined based on the tracked movement characteristics of the mobile devices. At step 915, host server 135 may perform one or more sub-processes 920, 930, 940, 950 and 960 relating to the identified group.

[1] Regarding sub-process 920, at step 922, host server 135 determines one or more group properties of the mobile devices of the group. These group properties may be determined based on movement characteristics (e.g., location, time, etc.) or other user/device information. Examples of such determined properties may include an average speed of the group, traffic pattern of the group, profile of the group, web browsing patterns of the group, or other common or similar activities engaged by the mobile devices (or substantially all the mobile devices), and so forth.

At step 924, host server 135 derives a group condition based on the group properties. For example, in a traffic embodiment, these conditions may include traffic condition (e.g., traffic pattern, traffic congestion, traffic jam, etc.) in a geographic region traveled by the mobile devices in the group. In a meeting or conference context, these conditions may include an attention level of the attendees based on the activity level or activities of the mobile devices.

At step 926, host server 135 provides the derived group condition to an interested party. The other party may be a mobile device in the group, a mobile device in another group which may be potentially interested in such information, a third party interested in such information such as a news agency, a traffic agency, a service provider for customizing service to one or more members of the group and so forth.

Additionally, host server 135 may identify a second group of mobile users having a potential interest in obtaining the derived group condition, and provide information corresponding to the derived group condition to the one or more mobile users of the second group. For example, in a traffic embodiment, the host server may derive a traffic condition, such as traffic congestion or traffic jam, at a particular geographic region (e.g., Route 24, section 2). In this scenario, the second group of mobile users may be mobile users traveling to the particular geographic region (e.g., mobile users traveling on Route 24, section 1). The host server may identify this second group of mobile users from a plurality of mobile users to inform them of the traffic congestion, and/or alternate routes to avoid the traffic congestion or jam.

[A] Road Traffic Example

One example may involve the determination of traffic conditions at a particular location. Host server 135 may identify a group of mobile devices from a plurality of mobile devices driving on a particular road (e.g., Route 24, section 1, etc.), determine a group property such an average speed or traffic pattern of the mobile devices in the group based on the movement of the devices, and derive a traffic condition based on the determined group property. Traffic conditions may include congested traffic flow, normal traffic flow, and so forth. This information may be provided to one or more mobile devices in the group, one or more mobile devices in a second group traveling towards the pertinent traffic area and/or a traffic-related agency, such as a traffic reporting agency or the like. This information may also be employed to customize services to the one or more mobile devices in the group, such as determining and providing alternative routes in the event of traffic congestion, providing traffic news services, etc.

[B] Communication Traffic Example

Another example may involve the determination of mobile communication conditions at a particular location, such as within a cell site. Host server 135 may identify a group of mobile devices at a particular location (e.g., cell site), determine a group property such an average number of calls or communications by the group (e.g., or group usage pattern), and derive communications conditions at the location based on group property. Such information may be employed by wireless communication provider(s) to increase communication efficiency, e.g., reroute calls or other wireless connections and so forth.

[2] Regarding sub-process 930, at step 932, host server 135 determines one or more group properties of the mobile devices of the group, such as discussed above. At step 934, host server 135 derives a group condition based on the group properties. At step 936, host server 135 customizes services and provides such customized services to one or more or all mobile devices of the group according to the derived group condition.

The types of customized services may include information of interest to members of the particular group (e.g., news, articles, traffic conditions, alternate routes, etc.), service opportunities of interest to members of the particular group, and so forth.

[3] Regarding sub-process 940, at step 942, host server 135 determines one or more group properties of the mobile devices of the group, such as discussed above. At step 944, host server 135 customizes services and provides such customized services to one or more or all mobile devices of the group according to the determined one or more group properties.

The types of customized services may include information of interest to members of the particular group (e.g., news, articles, traffic conditions, alternate routes, etc.), service opportunities of interest to members of the particular group, and so forth.

[4] Regarding sub-process 950, host server 135 may directly provide customized service to one or more members of the group based on the location-based activity at step 952. One example would be at a wedding. Once a group of mobile users attending a particular wedding is identified, it is possible to provide a number of customized services. These services may include wedding information (e.g., seating arrangements, information on the members of the wedding party, directions to the different sub-events (e.g., reception, dinner, etc.), registration (e.g., registering as a guest, etc.), data files concerning the wedding, other people attending the wedding, video games, and so forth. These services may be customized according to the particular mobile user, such as according to a profile of the mobile user.

[5] Regarding sub-process 960, host server 135 may provide information of the group of mobile devices to an interested party for use thereof at step 962. Such information may, for example, include movement information of the group, profile information of the members of the group, derived group properties (e.g., group velocity, group activity, group profile, etc.) and/or other characteristics associated with the user or the mobile devices themselves within the group. The other party may employ such information to determine environmental conditions (e.g., traffic conditions, etc.), to customize service to one or more members of the group, and so forth.

The types of customized services may include information of interest to members of the particular group (e.g., news, articles, traffic conditions, alternate routes, etc.), service opportunities of interest to members of the particular group, and so forth.

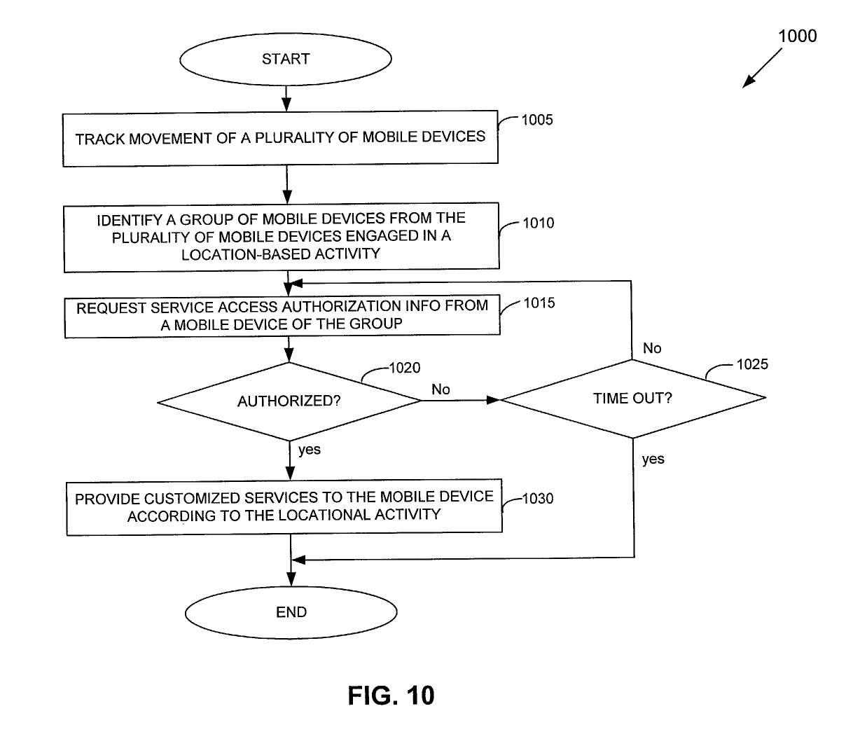

FIG. 10 illustrates an exemplary process 1000 by which services may be provided to mobile users on a group basis subject to proper authorization/authentication. The process 1000 commences at step 1005 in which host server 135 tracks movement of a plurality of mobile devices/users. At step 1010, host server 135 identifies a group of mobile devices sharing one or more similar or common traits, e.g., being engaged in one or more common or similar location-based activity. At step 1015, host server 135 requests service access authorization information from a mobile device of the group. At step 1020, host server 135 checks whether the mobile device is authorized based on received service authorization information. The authorization information may take various forms, such as password, pass code, certification (e.g., digital certificates) or other form of authentication such as voice, etc. At step 1025, if authorization information is not received or is incorrect, host server 135 may enable the mobile device 105 to resend/send authorization information up to some predetermined number of times or within some predefined time period before terminating the process.

Otherwise, if authorized, host server 135 provides customized services to the mobile device in the group based on the location-based activity, group property or profile, individual profile or data, etc.

Although authentication/authorization is discussed above with one embodiment in which services are provided, such authentication/authorization may be employed generally prior to any provision of services.

The many features and advantages of the present invention are apparent from the detailed specification and, thus, it is intended by the appended claims to cover all such features and advantages of the invention which fall within the true scope of the present invention.

Furthermore, since numerous modifications and variations will readily occur to those skilled in the art, it is not desired that the present invention be limited to the exact construction and operation illustrated and described herein; and accordingly, all suitable modifications and equivalents which may be resorted to are intended to fall within the scope of the claims.

What is claimed is:

1. A method of deriving information based on activities of a plurality of mobile users, the method comprising:
tracking movement of a plurality of mobile users across a wireless network;
identifying a group of mobile users engaged in a common location-based activity from the plurality of mobile users based on the tracked movement; and
determining a group property associated with the group of mobile users.

2. The method according to claim 1, wherein the location-based activity is selected from a group consisting of traveling in a geographic region, traveling to a geographic region, traveling from a geographic region, and being in a geographic region but not traveling.

3. The method according to claim 1, further comprising deriving a group condition based on the determined group property.

4. The method according to claim 3, wherein the derived group condition comprises a traffic condition in a geographic region.

5. The method according to claim 4, further comprising providing customized services to at least one mobile user of the group based on the derived traffic condition.

6. The method according to claim 5, wherein the customized services include providing alternate routes in the event the derived traffic condition corresponds to traffic congestion.

7. The method according to claim 3, further comprising providing information corresponding to the derived group condition to an interested party.

8. The method according to claim 3, further comprising:
identifying a second group of mobile users having a potential interest in obtaining the derived group condition; and
providing the derived group condition to the one or more mobile users of the second group.

9. The method according to claim 1, further comprising:
identifying a second group of mobile users having a potential interest in obtaining the determined group property; and
providing the determined group property to the one or more mobile users of the second group.

10. The method according to claim 1, further comprising dynamically updating group information corresponding to the mobile users of the group.

11. The method according to claim 10, wherein the updating includes modifying the group information to reflect one of an addition of a new mobile user to the group and a deletion of a mobile user from the group.

12. The method according to claim 10, wherein the updating includes modifying the group information to reflect new activity information of mobile users of the group.

13. The method according to claim 1, further comprising providing customized service to at least one mobile user of the group based on the one or more determined group properties.

14. The method according to claim 1, further comprising maintaining a database of information including at least one of group information corresponding to the mobile users of the group, group conditions and group properties.

15. The method according to claim 14, further comprising dynamically updating the database of information based on the activities of the plurality of mobile users.

16. The method according to claim 15, wherein the plurality of mobile users are tracked based on the database of information.

17. A method of providing services to a plurality of mobile users, the method comprising:
tracking the mobile users across a wireless network;
identifying a group of mobile users sharing one or more common traits from the mobile users; and
providing customized service to at least one mobile user of the group of mobile users based on the one or more common traits.

18. The method according to claim 17, wherein tracking the mobile users comprises tracking movement of the mobile users and identifying a group of mobile users comprises identifying a group of mobile users engaged in one or more common location-based activities.

19. A method of deriving information based on activities of mobile users, the method comprising:
tracking the mobile users across one or more wireless networks;
identifying a group of mobile users sharing one or more common traits from the mobile users; and
determining one of a group condition and a group property of the identified group of mobile users.

20. A system for deriving information based on the activity of mobile users, the system comprising:
memory medium for maintaining information corresponding to a movement of mobile users in order to track the movement of mobile users; and
at least one processor for identifying a group of mobile users engaged in one or more common location-based activities from the mobile users based on the tracked movement and for determining a group property associated with the group of mobile users.

21. The system according to claim 20, wherein the location-based activity is selected from a group consisting of traveling in a geographic region, traveling to a geographic region, traveling from a geographic region, and being in a geographic region but not traveling.

22. The system according to claim 20, wherein the processor further derives a group condition based on the determined group property.

23. The system according to claim 22, wherein the derived group condition comprises a traffic condition in a geographic region.

24. The system according to claim 23, wherein customized services are provided to at least one mobile user of the group based on the derived traffic condition.

25. The system according to claim 24, wherein the customized services include providing alternate routes in the event the derived traffic condition corresponds to traffic congestion.

26. The system according to claim 22, wherein information corresponding to the derived group condition is provided to an interested party.

27. The system according to claim 22, wherein a second group of mobile users having a potential interest in obtaining the derived group condition is identified, and the derived group condition is provided to the one or more mobile users of the second group.

28. The system according to claim 20, wherein a second group of mobile users having a potential interest in obtaining the determined group property is identified, and the determined group property is provided to the one or more mobile users of the second group.

29. The system according to claim 20, wherein group information corresponding to the mobile users of the group is dynamically updated.

30. The system according to claim 29, wherein the group information is updated by modifying the group information to reflect one of an addition of a new mobile user to the group and a deletion of a mobile user from the group.

31. The system according to claim 29, wherein the group information is updated by modifying the group information to reflect new activity information of mobile users of the group.

32. The system according to claim 20, wherein customized service is provided to at least one mobile user of the group based on the one or more determined group properties.

33. The system according to claim 20, wherein the memory medium further maintains a database of information including at least one of group information corresponding to the mobile users of the group, group conditions and group properties.

34. The system according to claim 33, wherein the database of information is dynamically updated based on the activities of the plurality of mobile users.

35. The system according to claim 34, wherein the plurality of mobile users is tracked based on the database of information.

36. A system for providing customized services to mobile users, comprising:
memory medium for maintaining information corresponding to the mobile users in order to track the mobile users; and
at least one processor for identifying a group of mobile users sharing one or more common traits from the mobile users and facilitating provision of customized service to at least one mobile user of the group based on the one or more common traits.

37. The system according to claim 36, wherein the memory medium maintains movement information of the mobile users to track the movement of the mobile users, and the processor identifies a group of mobile users engaged in one or more common location-based activities.

38. A system for determining group characterization of mobile users based on the activity of the mobile users, comprising:
memory medium for maintaining information on the mobile users to track the mobile users; and
at least one processor for identifying a group of mobile users sharing one or more common traits from the mobile users, and for determining one of a group condition and a group property of the identified group of mobile users.

39. A method of deriving information based on activities of a plurality of mobile users, the method comprising:
tracking movement of a plurality of mobile users operating mobile communication devices, across a wireless network;
identifying a group of mobile users traveling around a particular area;
determining a group velocity associated with the group of mobile users; and
deriving a traffic condition around the particular area based on the determined group velocity.
